(19) United States
(12) Patent Application Publication
(10) Pub. No.: US 2010/0325124 A1
(43) Pub. Date: Dec. 23, 2010

(54) TUNING QUERY EXECUTION PERFORMANCE OF A DATABASE SYSTEM

(75) Inventors: Juan Wu, Union City, CA (US); Sudipto Rai Chowdhuri, San Ramon, CA (US)

Correspondence Address: Sterne, Kessler, Goldstein & Fox P.L.L.C., 1100 New York Avenue, N.W., Washington, DC, 20005, US

(73) Assignee: Sybase, Inc., Dublin, CA (US)

(21) Appl. No.: 12/486,475

(22) Filed: Jun. 17, 2009

(51) Int. Cl. G06F 17/30

(52) U.S. Cl. 707/759; 707/769; 707/805; 707/713

(57) ABSTRACT

Methods, systems, and computer program products for tuning query execution performance in a database management system are described. In an embodiment, query performance issues of chosen database operational logic in a database management system are identified with an external utility provided for use on top of the database management system. The identified query performance issues are resolved selectively in the database management system without modifying the chosen database operational logic.

### BACKGROUND

1. Field of the Invention

The present invention is directed to tuning query execution performance of a database system.

2. Background Art

Computers are very powerful tools for storing and providing access to vast amounts of information. Databases are a common mechanism for storing information on computer systems while providing easy access to users. A typical relational database is an organized collection of related information stored as “records” having “fields” of information. As an example, a database of employees may have a record for each employee where each record contains fields designating specifics about the employee, such as name, home address, salary, and the like.

Between the actual physical database itself (i.e., the data actually stored on a storage device) and the users of the system, a database management system or DBMS is typically provided as a software cushion or layer. In essence, the DBMS shields the database user from knowing or even caring about the underlying hardware-level details.

One purpose of a database system is to answer queries requesting information from the database. A query may be defined as a logical expression over the data and the data relationships set forth in the database, and execution of a query results in the identification of a subset of the records in the database. In operation, for instance, the execution of a request for information from a relational DBMS is typically issued by a client system as one or more Structured Query Language or “SQL” queries for retrieving particular data (e.g., a list of all employees earning more than $25,000) from database tables on a server. In response to this request, the database system typically returns the names of those employees earning $25,000, where “employees” is a table defined to include information about employees of a particular organization. The syntax of SQL is well documented, see e.g., “Information Technology—Database languages—SQL”, published by the American National Standards Institute as American National Standard ANSI/ISO/IEC 9075: 1992, the disclosure of which is hereby incorporated by reference.

SQL queries express what results are requested but do not state how the results should be obtained. In other words, the query itself does not tell how the query should be evaluated by the DBMS. Rather, a component of the DBMS called the optimizer determines the “plan” or the best method of accessing the data to implement the SQL query. The query optimizer is responsible for transforming a SQL request into an access plan composed of specific implementations of the algebraic operator selection, projection, join, and so forth. The role of a query optimizer in a relational DBMS system is to find an adequate execution plan from a search space of many semantically equivalent alternatives.

Relational database queries are broadly classified into simple transactional queries found in online transaction processing (OLTP) environments, and complex queries found in operational decision support system (DSS) environments. Although existing database systems are in wide use in DSS applications and in OLTP applications, there is a growing user demand for supporting both types of queries in a single system. Users need a solution capable of handling complex queries and also having the ability to process large data sets for both local and distributed systems. They are looking for a robust database server system platform for running mixed workload applications that demand superior performance for queries from both OLTP and DSS domains, sometimes across distributed and heterogeneous database servers. This environment is referred to as an operational decision support system (operational DSS), since it allows running complex queries as well as performing regular OLTP processing.

While a query optimizer helps meet the demands placed on the database system in this type of environment, which involves running complex queries as well as regular OLTP processing, different optimization goals or database system settings can result in different performance in query execution. An optimization goal refers to a set of criteria that allows the query optimizer to apply a set of transformation rules to generate an optimal query plan for a specific workload. For example, an index nested loop join is best used in a pure OLTP environment but may not be applicable in a DSS type workload. The difference is aggravated by the fact that standard goals often do not capture all of the different possibilities that different types of queries may have. Further, the process of identifying the best goal or plan for a query can be labor intensive. And, applying fixes for these problematic queries is non-trivial.

One of the issues to be addressed in this type of processing environment is the ability to tune query execution performance for chosen database operational logic. The present invention provides a solution for these and other needs.

### BRIEF SUMMARY

Briefly stated, the invention includes system, method, computer program product embodiments and combinations and sub-combinations thereof for tuning query execution performance in a database management system are described.

In an embodiment, query performance issues of chosen database operational logic in a database management system are identified with an external utility provided for use on top of the database management system. The identified query performance issues are resolved selectively in the database management system without modifying the chosen database operational logic.

Further embodiments, features, and advantages of the invention, as well as the structure and operation of the various embodiments of the invention, are described in detail below with reference to accompanying drawings.

### BRIEF DESCRIPTION OF THE DRAWINGS/FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 illustrates an exemplary database management system (DBMS), according to an embodiment of the invention.

FIG. 2 illustrates a utility for query execution performance tuning for use with the DBMS of FIG. 1, according to an embodiment of the invention.

FIG. 3 is a flowchart illustrating an exemplary overall operation of query execution performance tuning according to an embodiment of the invention.

FIG. 4 is a flowchart illustrating an exemplary operation of fixing missing statistics in order to improve query execution performance using the query performance tuning utility, according to an embodiment of the invention.

FIG. 5 is a flowchart illustrating an exemplary operation of fixing query plans in order to improve query execution performance using the query performance tuning utility, according to another embodiment of the invention.

FIG. 6 illustrates an example computer useful for implementing components of embodiments of the invention.

The features and advantages of the present invention will become more apparent from the detailed description set forth below when taken in conjunction with the drawings. In the drawings, like reference numbers generally indicate identical, functionally similar, and/or structurally similar elements. Generally, the drawing in which an element first appears is indicated by the leftmost digit(s) in the corresponding reference number.

### DETAILED DESCRIPTION

The present invention relates to a system, method, computer program product embodiments and combinations and sub-combinations thereof for tuning query execution performance of a database system.

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

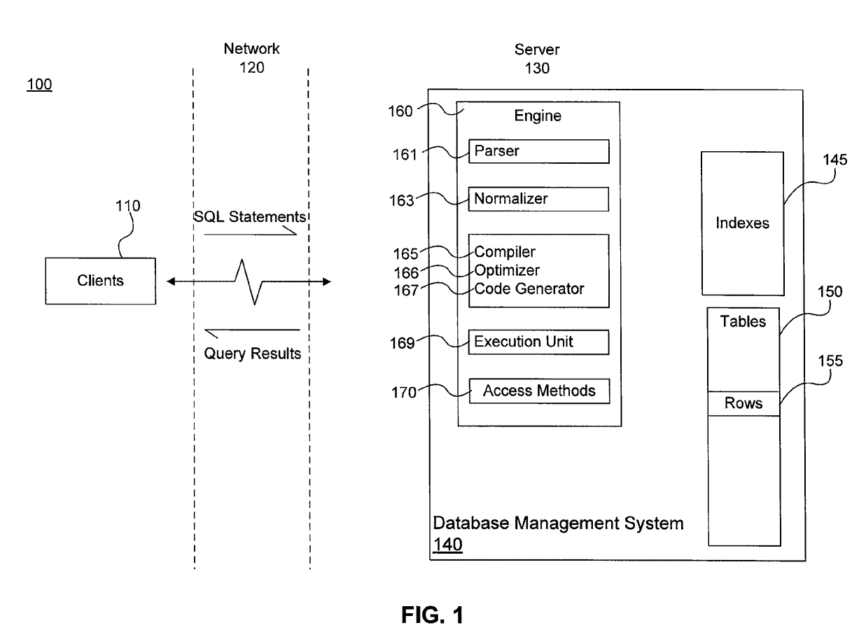

Embodiments of the invention may operate in the example client/server database system 100 shown in FIG. 1. System 100 includes one or more clients 110 in communication with a server 130 via a network 120. A database management system (DBMS) 140 resides in the server 130. It is noted that the example client/server database system 100 is shown in FIG. 1 and discussed herein solely for purposes of illustration, and not limitation. The invention is not limited to the example of FIG. 1.

In operation, clients 110 store data in, or retrieve data from, rows 155 of database tables 150 by issuing SQL statements to DBMS 140. SQL statements received from clients 110 are processed by query engine 160 of the DBMS 140. SQL is well known and is described in many publicly available documents, including “Information Technology—Database languages—SQL,” published by the American National Standards Institute as American National Standard ANSI/ISO/IEC 9075: 1992, which is hereby incorporated by reference in its entirety.

In an embodiment, query engine 160 comprises parser 161, normalizer 163, compiler 165, query optimizer 166, code generator 167, execution unit 169 and access methods 170, which shall now be generally described.

SQL statements received from clients 110 are passed to the parser 161 which converts the statements into a query tree, which is a binary tree data structure that represents the components of the query in a format selected for the convenience of the system. In this regard, the parser 161 employs well known parsing methodology (e.g., recursive descent parsing).

The query tree is normalized by the normalizer 163. Normalization includes, for example, the elimination of redundant data. Additionally, the normalizer 163 may perform error checking, such as confirming that table names and column names which appear in the query are valid (e.g., are available and belong together). Finally, the normalizer 163 may also look up any referential integrity constraints which exist and add those to the query.

After normalization, the query tree is passed to the compiler 165, which includes query optimizer 166 and a code generator 167. Query optimizer 166 is responsible for optimizing the query tree. In an embodiment, query optimizer 166 performs a cost-based analysis for formulating a query execution plan. Query optimizer 166 will, for example, select the join order of tables, and select relevant indexes 145. Query optimizer 166, therefore, performs an analysis of the query and determines the best execution plan, from a plurality of generated execution plans, and where “best” is judged according to any defined criteria, which in turn results in particular access methods 170 being invoked during query execution by the execution unit 169.

A general goal of a query optimizer is to speed up the process of executing a query and returning the results. In general terms, speeding up a query (i.e., reducing query response time) can be achieved in two different ways. A first way to achieve the goal of reducing response time is by reducing the total amount of work that needs to be done in executing the query. A second way to achieve this goal is divide (or partition) the work that needs to be done in executing the query among multiple processors. This can allow a given query to take advantage of unutilized (or underutilized) resources. An example of a suitable query optimizer that minimizes query response time by judiciously interleaving and balancing the execution primitives to take advantage of the available resources, with the assumption that throughput remains unchanged is described in co-pending U.S. patent application Ser. No. 10/711,931, entitled “Database System with Methodology for Parallel Schedule Generation in a Query Optimizer”, filed on Oct. 13, 2004, and assigned to the assignee of the present invention, the details of which are incorporated herein by reference in their entirety.

In the type of environment which involves running complex queries as well as regular OLTP processing, different optimization goals or database system settings can result in different performance in query execution. The difference is aggravated by the fact that standard goals of a query optimizer often do not capture all of the different possibilities that different types of queries may have. Further, the process of identifying the best goal or plan for a query can be labor intensive, while applying fixes for these problematic queries is non-trivial.

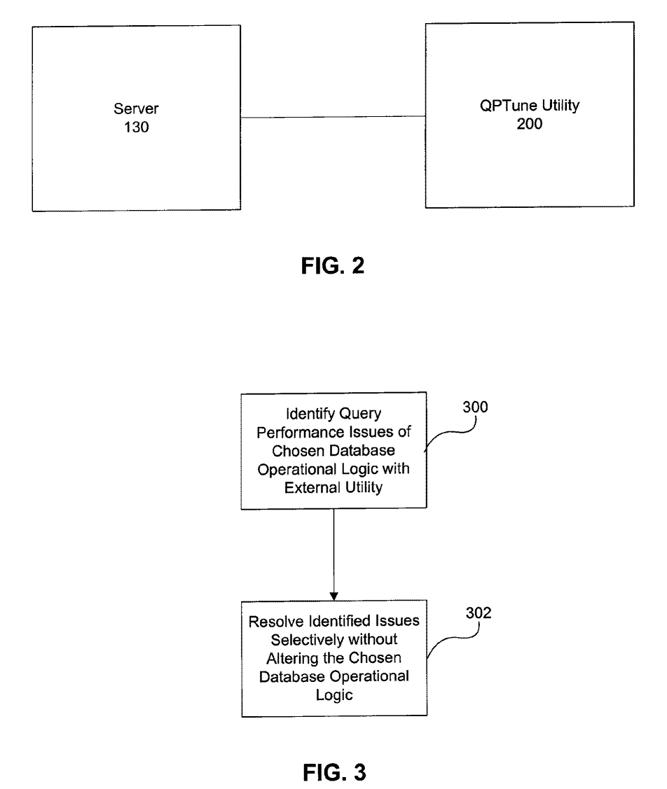

In accordance with embodiments of the present invention, a query execution performance tuning approach is provided to alleviate these difficulties. Referring to FIG. 2, a query performance tune utility (QPTune) 200 is shown that operates in conjunction with the server 130. In a preferred embodiment, the utility 200 provides program commands external to the server 130 that are written in Java/XML and enables users to identify missing statistics and update them and identify the best query plan, optimization goals, or other configuration settings, and apply them at the server 130 or query level, which results in optimal performance of subsequent query executions. The use of the utility 200 provides for identifying query performance issues of chosen database operational logic in the database management system (block 300), and resolving the identified query performance issues selectively in the database management system 140 of the server 130 without modifying the chosen database operational logic (block 302), as represented in FIG. 3.

In the subsequent description of various embodiments of the utility 200 operations, reference is made to invoking the utility 200 according to a particular syntax. This syntax, which follows, is meant as illustrative and not restrictive of the invention.

QPTune [-U <username>] [-P <password>] [-S <hostname:port/database>] [-A <action [start|collect(_full)|compare|fix|(start|collect|fix|undo_fix)_stats]>] [-M <mode>] [-T <appTime>] [-i <inputFile>] [-o <outputFile>][-f <fileList(,)>] [-c <configFile>] [-l <limit>] [-e <evalField>][-d <diff%(,diff_abs)>] [-m <missingCount>] [-n <login>] [-J <charset>][-N (noexec)] [-g (applyOptgoal)][-v (verbose)] [-s (sort)] [-h (help)]

where the parameters refer to

-U username specifies the database user name.

-P password specifies the database password.

-S server specifies the database server. The database server is denoted by host:port/database.

-A action specifies the action to be taken. In an embodiment, the actions include one of: start, collect, collect_full, compare, fix, start_stats, collect_stats, fix_stats, and undo_fix_stats.

-J charset specifies the character set used to connect to the database management server. If this option is not specified, the server's default character set is used.

-M mode specifies the optimization goal or custom mode for an application. In an embodiment, the modes include one of: allrows_oltp, allrows_dss, allrows_mix, or a defined custom mode, where allrows_oltp offers the narrowest selection of access methods, allrows_dss offers the widest selection of access methods, and allrows_mix offers access method selection between the narrowest and widest.

-T appTime specifies the application running time, in minutes.

-o outputFile specifies the output file.

-i inputFile specifies the input file for the ‘fix’ action. It can also be used to apply special rules to the specified queries for the ‘start’ and ‘collect’ actions for custom modes.

-f fileList compares a list of files to get the best plans, with filenames separated by the use of ‘commas’. Quotes can be used to encapsulate the file name if it contains any spaces.

-c configFile specifies the configuration file.

-l limit specifies a limit on the number of queries that should be analyzed and applied with special rules.

-e evalField evaluation field used for performance comparison.

-d difference specifies the percentage and absolute value difference for performance improvement to be considered outstanding. Percentage values are between 0 and 100; an absolute value can be any number greater than 0.

-N used along with the ‘fix_stats’ and ‘undo_fix_stats’ actions, -N generates a SQL script with ‘update statistics’ or ‘delete statistics’ statements, which are not executed through the utility and are written into a SQL script that is specified by the -o option.

-n login specifies the user's login whose query executions are collected and analyzed.

-m missingCount specifies the threshold value for missing statistics.

-v specifies verbose mode.

-g when used along with the ‘fix’ action, applies the default goal, where the default goal refers to the best optimization goal setting that most queries used as the best plan using the utility's ‘fix’ action, and will only generate plans for queries that do not currently use the server's default optimization goal.

Default values can be designated and used if specific values are not indicated for the parameters, such as:

-A: collect

-M: allrows_dss

-T: 0

-o: metrics.xml

-c: config.xml

-e: elap_avg

-d: 5,5. If only a percentage is specified, absolute value defaults to 0.

-l limit

-m 5

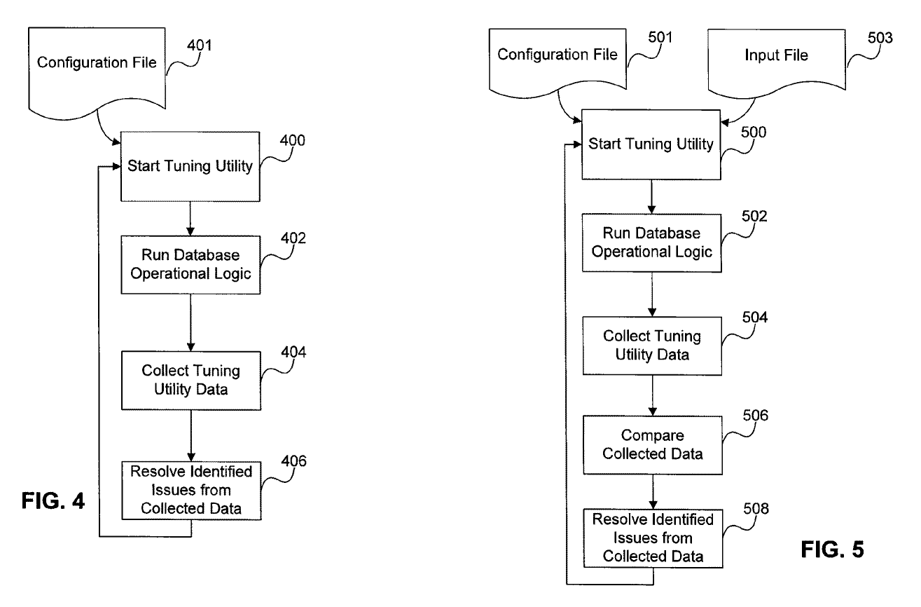

In an embodiment, the utility 200 is invoked to identify a query performance issue related to fixing or updating missing statistics needed by the query optimizer 166, such as after a DBMS server upgrade, as described with reference to the flow diagram of FIG. 4. The process initiates with the starting of the utility 200 (block 400). By way of example, starting of the utility occurs by using the “start_stats” action in the syntax:

QPTune -A start_stats -S my_host:4816/my_database -v

The invocation results in the following sample output:

Executing : QPTune -U sa -P [unshown] -S
jdbc:sybase:Tds:my_host:4816/my_database -A start_stats
-M allrows_dss -T 0 -i
null -o metrics.xml -f null -c config.xml -l 5 -e elap_avg -d 5,5
-m 5 -n null -v
You are now connected to database: my_database
[INFO] Config: sp_configure ‘capture missing statistics’, 1
[INFO] Config: sp_configure ‘system table’, 1
[INFO] Config: delete sysstatistics where formatid =110

The ‘-c’ option, when used in the syntax, specifies a configuration file 401, which in the example is “config.xml”, so that the server-level configuration settings are extracted from the <start_stats> section of the configuration file.

The process continues with the running of the chosen database operational logic, e.g., the application, queries, or stored procedure (block 402).

Any missing statistics information for the chosen database operational logic is collected into a specified output file via the “collect_stats” action being invoked (block 404). In an embodiment, the action can be performed immediately or after waiting for some period of time, which allows for the automation of the “start_stats” and “collect_stats” actions, as is well appreciated by those skilled in the art. The operation of the “collect_stats” action results in the retrieval of missing statistics information from the system statistics (e.g., sysstatistics) table for statistics that exceed a specified threshold for a count of missing statistics. Thus, when the statistics for a query have been missed as many times as the threshold value or more, they are collected and exported to an XML file. Consolidation of the missing statistics by the external utility 200 results with a determination of a minimum set of statistics that must be updated.

The specified threshold suitably is indicated via the -m option in the syntax. The -o option in the syntax allows for the indication of the output XML file that holds missing statistics. The output XML from “collect_stats” may then be used as an input to the “fix_stats” and “undo_fix_stats” actions, described below. As an example:

QPTune -A collect_stats -m 1 -o missingstats.xml -v -S my_host:4816/my_database

The following is sample output:

```
  Executing : QPTune -U sa -P [unshown] -S
  jdbc:sybase:Tds:my_host:4816/my_database -A collect_stats
  -M allrows_dss -T 0
  -i null -o missingstats.xml -f null -c config.xml -l 5 -e elap_avg
  -d 5,5 -m 1 -n null
  -v
  You are now connected to database: my_database
  Now collecting missing statistics information from sysstatistics
on “Fri Sep 26 10:08:06 PDT 2008”.
  <?xml version=“1.0” encoding=“UTF-8”?>
  <server url=“jdbc:sybase:Tds:my_host:4816/my_database”
  file=“missingstats.xml”
  type=“missing stats” datetime=“Fri Sep 26 10:08:06 PDT 2008”>
  <missingStat id=“1”>
  <id>1068527809</id>
  <stats>employees(age,firstname)</stats>
  <count>2</count>
  </missingStat>
  <missingStat id=“2”>
  <id>1068527809</id>
  <stats>employees(lastname)</stats>
  <count>1</count>
  </missingStat>
  <missingStat id=“3”>
  <id>1068527809</id>
  <stats>employees(firstname,ID)</stats>
  <count>1</count>
  </missingStat>
  <missingStat id=“4”>
  <id>1068527809</id>
  <stats>employees(ID)</stats>
  <count>1</count>
  </missingStat>
  </server>
  The missing statistics information is written into
  XML file: missingstats.xml
  [INFO] End config: sp_configure ‘enable metrics capture’, 0
  [INFO] End config: sp_configure ‘abstract plan dump’, 0
  [INFO] End config: sp_configure ‘system table’, 0
  [INFO] End config: sp_configure ‘capture missing statistics’, 0
```

Program has restored the data source for metrics collection.

Once collected, fixing of the statistics occurs (block 406), e.g., via indication of the “fix_stats” action in the syntax from an input file specified via -i option, e.g., missingstats.xml, in the continuation of the example:

QPTune -A fix_stats -m 1 -i missingstats.xml -v -S my_host:4816/my_database

The following is sample output:

```
  Executing : QPTune -U sa -P
[unshown] -S dbc:sybase:Tds:my_host:4816/my_database
-A fix_stats -M allrows_dss -T 0 -i
missingstats.xml -o metrics.xml -f null -c config.xml -l 5 -e
elap_avg -d 5,5 -m 1 -n null - v
  You are now connected to database: my_database
  Fix statistics on “Fri Sep 26 10:14:59 PDT 2008”
  -----------------------------------------------------------
  Details of statements(s) fixed:
  -------------------------------
  Fixed statistics:[Update] employees(age,firstname)
  [INFO] Fix Statement = update statistics employees(age,firstname)
  Fixed statistics:[Update] employees(lastname)
  [INFO] Fix Statement = update statistics employees(lastname)
  Fixed statistics:[Update] employees(firstname,ID)
  [INFO] Fix Statement = update statistics employees(firstname,ID)
  Fixed statistics:[Update] employees(ID)
  [INFO] Fix Statement = update statistics employees(ID)
  ----- QPTune finished executing. -----
```

A further option exists to undo/revert the fix of missing statistics, e.g., by using the “undo_fix_stats” action, which deletes the statistics that are specified in the XML file whose missing counts are equal to, or exceed, the number specified by the -m option. Continuing with the same example,

QPTune -A undo_fix_stats -m 1 -i missingstats.xml -v -S my_host:4816/my_database

The following is sample output:

```
  Executing: QPTune -U sa -P
[unshown] -S jdbc:sybase:Tds:my_host:4816/my_database
-A undo_fix_stats -M allrows_dss -T 0 -i
missingstats.xml -o metrics.xml -f null -c config.xml -l 5
-e elap_avg -d 5,5 -m 1 -n null - v
  You are now connected to database: my_database
  Fix statistics on “Fri Sep 26 10:20:23 PDT 2008”
  --------------------------------------------------------
  Details of statements(s) fixed:
  -------------------------------
  Fixed statistics:[Delete] employees(age,firstname)
  [INFO] Fix Statement = delete statistics employees(age,firstname)
  Fixed statistics:[Delete] employees(lastname)
  [INFO] Fix Statement = delete statistics employees(lastname)
  Fixed statistics:[Delete] employees(firstname,ID)
  [INFO] Fix Statement = delete statistics employees(firstname,ID)
  Fixed statistics:[Delete] employees(ID)
  [INFO] Fix Statement = delete statistics employees(ID)
  ----- QPTune finished executing. ------
```

In the utilization of fixing missing statistics on undo fixing missing statistics, there may be times when generation of a SQL script in a SQL file format for updating statistics is desired without executing the actual updates results. The syntax allows for this by using the -N option to indicate “noexec”, and the -o option to indicate the output script file. The output file is created with all the generated “update statistics” or “delete statistics” statements, as shown above, but the statements are not executed. In this manner, utilization of the -N option provides the option of running the SQL script at a later time to optimize resources if desired.

In an alternate embodiment, the external utility 200 is utilized to identify a query performance issue related to optimization of a query, application, or stored procedure, as described with reference to FIG. 5. The process follows a similar flow as in FIG. 4 with some additional processing. The process initiates with the starting the utility (block 500), which can occur using either a simple start to apply standard optimization goal settings, or a custom start to apply special/custom rules to specified queries, via a configuration file 501 and an input file of queries 503. By way of example, the following syntax is presented to represent applying standard optimization goal settings:

QPTune -S host:port/database -A start [-M {allrows_oltp, allrows_dss, allrows_mix}]

Use of the -M options shown invokes one of the pre-programmed modes, which, in an embodiment, correspond to three optimization goals of the query optimizer, e.g., allrows_mix, allrows_oltp, and allrows_dss (previously indicated as a default mode).

Alternatively, an example of the syntax for a custom start is:

QPTune -S my_host:4816/my_database -A start -M custom_{—}1 -i input.xml -l 3 [-v]

Use of the -M option in a custom mode allows for specifying a group of special rules indicated under the <mode> section of the configuration file 501. In the ASE environment, for example, the special rules indicate optimization criteria that are applicable at the query level using abstract query plans. A description of abstract query plans can be found in U.S. Pat. No. 6,618,719, entitled Database System with Methodology for Reusing Cost-based Optimization, issued Sep. 9, 2003 and assigned to the assignee of the present invention

The custom mode called custom_{—}1 in the example syntax provides a combination of optimization rules such as, use optgoal allrows_mix, use merge_join off and use opttimeoutlimit 15, where merge_join off would disable merge joins and opttimeout limit 15 would time out optimization once 15% of the estimated execution time is spent on optimization. The -i option is used to indicate an input file 503, input.xml, that contains SQL text for the queries. Use of the -l option along with the -i option indicates the number of queries that should be applied with these special rules. Counting of the queries suitably occurs from the start of the file. Using a value of 0 for the -l option implies that all queries in the input file are applied.

Once started in the desired mode, the chosen database operational logic (e.g., application, queries, or stored procedure) is run (block 502). Collection of the metrics into a specified XML file follows (block 504), such that while applying a standard goal setting during the ‘collect’ phase, a number of collected metrics files subsequently may be compared to generate a file with the best goal settings. For example, the command below collects the data into a file named a2.xml. The custom mode is depicted within the <bestmode> tags.

QPTune -S my_host:4816/my_database -A collect -T 0-o a2.xml -v

The following is sample output:

```
  Program has configured the data source for metrics collection.
  Now collecting information from sysquerymetrics on
“Tue Feb 17 22:16:04 PST 2009”.
  <?xml version=“1.0” encoding=“UTF-8”?>
  <server url=“jdbc:sybase:Tds:my_host:4816/my_database”
type=“ASE” mode=“custom_1” datetime=“Tue Feb 17 22:16:04
PST 2009”>
  <query id=“1”>
  <qtext> select count(T.title_id) from authors A, titleauthor T
  where A.au_id = T.au_id </qtext>
  <elap_avg>50</elap_avg>
  <bestmode> custom_1
  </bestmode>
  </query>
  ......
  </server>
```

Use of the -o option in the syntax allows for specifying the output metrics file, while the -v option provides a verbose output. Further, by specifying the -T option, collection can occur at particular times, e.g., immediately, using the -T 0 option, or after t minutes, using the -T t option.

The sets of metrics that have been collected for different optimization goals or custom rules are then used as input files for generating a performance comparison report (block 506). The comparison of the different XML files allows the best query optimization goal or criteria for each of the queries to be determined. For example:

QPTune -A compare -f a1.xml,a2.xml -d 51,10 -o best.xml -S my_host:4816/my_database

The -f option specifies a list of two or more collected metrics sample files separated by commas, e.g., a1.xml, a2.xml . . . . The -d option indicates a threshold percentage (e.g., 51%) and absolute value (e.g., 10) for performance improvement, where a performance improvement beyond the threshold percentage and absolute value is considered “outstanding” during a subsequent fix operation. The optimization goal/criteria for those outstanding queries is applied to the server as a plan fix to the query optimizer 166, as is commonly understood.

The -o option specifies the file for the result of the comparison (best.xml). The file holds the best setting for all the queries being analyzed. The following shows the sample output of a “compare” operation:

```
  Compare all the files: | a1.xml, a2.xml|
  Report generated on “Tue Aug 19 21:13:04 PST 2008”
  --------------------------------------------------------------------------
  File #1: [name= a1.xml : mode=allrows_mix]
  File #2: [name= a2.xml : mode=custom_1]
  Query count in File #1 : [mode=allrows_mix] 6
  Query count in File #2 : [mode=custom_1] 7
  ====================================================
  Query count improved in File #2: [mode=custom_1] 3
  Total performance improved [from 422 to 129]: 69 %
  Following queries run better in File #2:
  [mode= custom_1]
  --------------------------------------------------------------------------
  Group 1: improved by no more than 25% [0 queries]
  Group 2: improved by 25% to 50% [1 queries]
  Query: select count(T.title_id) from authors A, titleauthors T where
A.au_id = T.au_id
  Average elapsed time (ms): File #1=100 File #2=50
  Improvement=50.0% Outstanding=No
  Group 3: improved by 50% to 75% [0 queries]
  Group 4: improved by 75% to 100% [2 queries]
  Query: select count(*) from titles T, titleauthors TA where T.title_id =
  TA.title_id
  Average elapsed time (ms): File #1=34 File #2=7
  Improvement=79.0% Outstanding=Yes
  Query: select au_lname, au_fname from authors where state
  in (“CA”, “AZ”)
  Average elapsed time (ms): File #1=9 File #2=0
  Improvement=100.0% Outstanding=No
```

The above example shows a comparison between two XML metrics files, a1.xml, which has six queries, and a2.xml, which has seven queries. Comparisons are made only between the queries that are common to both files, and the file with the largest set of queries is used as the basis for comparison when using “-s” option to enable sorting. Reviewing the example comparison elicits three queries that ran faster in a2.xml. The improvements are categorized into four groups:

Group 1—between 0 and 25%

Group 2—between 25% and 50%

Group 3—between 50% and 75%

Group 4—between 75% and 100%

There is one query in Group 2 between 25 and 50% and two queries in Group 4 between 75% and 100%. The queries in Group 2 are marked as “Outstanding=No” which means that based on the threshold of 51%, this query will not be fixed. While comparing more than two files, the utility 200 updates the first file with the best from both files, then compares the new file with the third file, and so on. Once the comparison is done, the process proceeds with applying the best results from the comparison to each of the specified queries on the target server (block 508) through the use of the “fix” action in the syntax. For example:

QPTune -S my_host:4816/my_database -A fix -i best.xml -v -g

The -i option specifies the queries and their best plans resulting from the comparison (e.g., ‘best.xml’). The example “fix” action above produces this sample output:

```
  Query Plan(s) fixed on “Wed Sep 17 17:44:09 PDT 2008”
  --------------------------------------------------------------
  Fixed 1 query using mode “custom_1” with following optimizer
settings“: ‘(use optgoal allrows_mix) (use merge_join off)
(use opttimeoutlimit 15)’
  Fixed 5 query using mode “allrows_mix”
  Apply “sp_configure optimization_goal, 0, allrows_mix” as the
default optgoal
  Details of statement(s) fixed:
  ---------------------------------------
  Query: ‘ select count(*) from titles T, titleauthors TA where
T.title_id = TA.title_id’
  Fixed using: ‘custom_1’
  [INFO] Fix Statement = create plan ‘ select count(*) from titles T,
titleauthors TA where T.title_id = TA.title_id ’
‘(use optgoal allrows_mix) (use merge_join off) (use
opttimeoutlimit 15)’
```

As a result, an optimized query plan is created and preferably is saved in the appropriate system table in the current database, e.g., sysqueryplans for the ASE environment. Thus, in future operations, when a query with matching SQL is encountered, this optimized plan is used. In an embodiment, incoming SQL and the SQL of the optimized query plan are said to match if literal parameterization is enabled and the two statements differ only in the static values of search arguments such as, where CustomerID=“12345”. Of course, if the chosen database operation logic changes the SQL in any manner, such as by adding a new predicate, there is no longer a match to an optimized query plan and the query optimizer creates a query plan according to the current configuration and available statistics.

Through the embodiments of the present invention, query execution performance tuning can be achieved that fixes missing statistics in an application, tunes an application to find the best optimizer settings for any number of queries, and/or selectively applies customized or standard settings to specific queries. Further, through the use of the described utility of the invention, an analysis and comparison of any number of configuration settings or database server installations can be accomplished to generate a performance impact analysis report, or to perform plan fixes without degrading the server's performance. Query plans are fixed using DDL (data definition language) statements that have little impact on the overall performance of the system. In addition, the utility allows different threshold levels for monitoring, thereby reducing the metrics that need to be collected. Overall, the embodiments of the present invention provide an advisory tool for user-defined rules that can be mixed and matched for determining best use of a query optimizer.

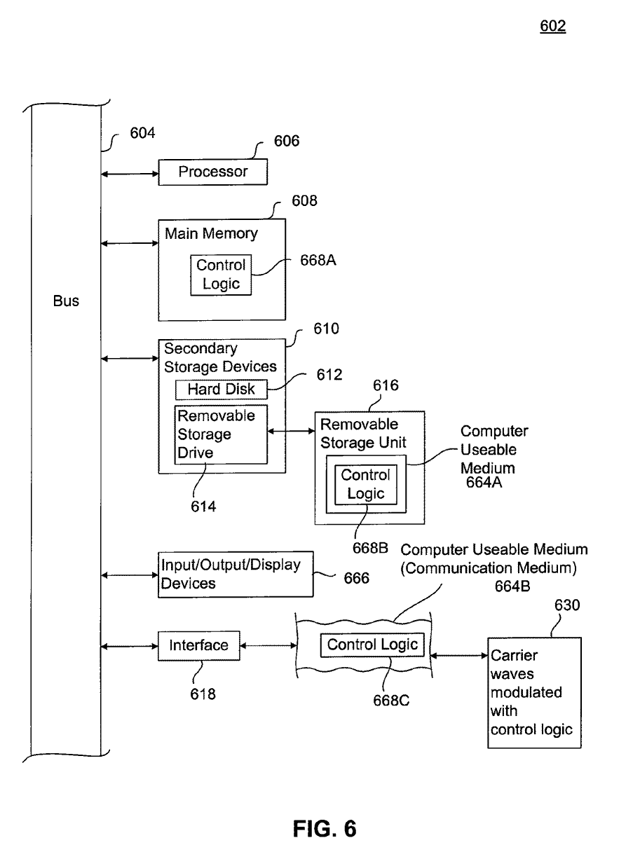

In an embodiment of the present invention, the system and components of embodiments described herein are implemented using well known computers, such as example computer 602 shown in FIG. 6. For example, database management system 140 or server 130 can be implemented using computer(s) 602.

The computer 602 can be any commercially available and well known computer capable of performing the functions described herein, such as computers available from International Business Machines, Apple, Sun, HP, Dell, Compaq, Digital, Cray, etc.

The computer 602 includes one or more processors (also called central processing units, or CPUs), such as a processor 606. The processor 606 is connected to a communication bus 604.

The computer 602 also includes a main or primary memory 608, such as random access memory (RAM). The primary memory 608 has stored therein control logic 668A (computer software), and data.

The computer 602 also includes one or more secondary storage devices 610. The secondary storage devices 610 include, for example, a hard disk drive 612 and/or a removable storage device or drive 614, as well as other types of storage devices, such as memory cards and memory sticks. The removable storage drive 614 represents a floppy disk drive, a magnetic tape drive, a compact disk drive, an optical storage device, tape backup, etc.

The removable storage drive 614 interacts with a removable storage unit 616. The removable storage unit 616 includes a computer useable or readable storage medium 664A having stored therein computer software 628B (control logic) and/or data. Removable storage unit 616 represents a floppy disk 668B, magnetic tape, compact disk, DVD, optical storage disk, or any other computer data storage device. The removable storage drive 614 reads from and/or writes to the removable storage unit 616 in a well known manner.

The computer 602 also includes input/output/display devices 666, such as monitors, keyboards, pointing devices, etc.

The computer 602 further includes a communication or network interface 618. The network interface 618 enables the computer 602 to communicate with remote devices. For example, the network interface 618 allows the computer 602 to communicate over communication networks or mediums 664B (representing a form of a computer useable or readable medium), such as LANs, WANs, the Internet, etc. The network interface 618 may interface with remote sites or networks via wired or wireless connections.

Control logic 668C may be transmitted to and from the computer 602 via the communication medium 664B. More particularly, the computer 602 may receive and transmit carrier waves (electromagnetic signals) modulated with control logic 630 via the communication medium 664B.

Any apparatus or manufacture comprising a computer useable or readable medium having control logic (software) stored therein is referred to herein as a computer program product or program storage device. This includes, but is not limited to, the computer 602, the main memory 608, secondary storage devices 610, the removable storage unit 616 and the carrier waves modulated with control logic 630. Such computer program products, having control logic stored therein that, when executed by one or more data processing devices, cause such data processing devices to operate as described herein, represent embodiments of the invention.

The invention can work with software, hardware, and/or operating system implementations other than those described herein. Any software, hardware, and operating system implementations suitable for performing the functions described herein can be used.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A computer-implemented method for tuning query execution performance in a database management system, the method comprising:
identifying query performance issues of chosen database operational logic in a database management system with an external utility provided for use on top of the database management system; and
resolving identified query performance issues selectively in the database management system without modifying the chosen database operational logic.

2. The computer-implemented method of claim 1 wherein the database operational logic further comprises at least one of a query, a stored procedure, and an application.

3. The computer-implemented method of claim 1 wherein identifying query performance issues further comprises identifying missing statistics for the chosen database operational logic.

4. The computer-implemented method of claim 3 wherein resolving further comprises updating statistics in the database management system for the database operational logic with statistics found by the external utility.

5. The computer-implemented method of claim 1 wherein identifying query performance issues further comprises identifying suboptimal query optimization settings.

6. The computer-implemented method of claim 5 wherein resolving further comprises collecting performance metrics and statistical information during operation by a query optimizer of the database management system and providing query plan fixes to the query optimizer.

7. The computer-implemented method of claim 6 wherein providing query plan fixes further comprises associating a query to a prescribed plan and storing the query with the plan fix in a system catalog of the database management system for subsequent utilization by the query optimizer.

8. A system for tuning query performance in a database management system, the system comprising:
a database management means; and
a utility means for use with the database management means and external to the database management means, the utility means for identifying query performance issues of chosen database operational logic in the database management means and for resolving identified query performance issues selectively in the database management means without modifying the chosen database operational logic.

9. The system of claim 8 wherein the database operational logic further comprises at least one of a query, a stored procedure, and an application.

10. The system of claim 8 wherein utility means further identifies missing statistics for the chosen database operational logic.

11. The system of claim 10 wherein the utility means further updates statistics in the database management system for the database operational logic for the identified missing statistics.

12. The system of claim 8 wherein the utility means further identifies suboptimal query optimization settings.

13. The system of claim 12 wherein the utility means collects performance metrics and statistical information during operation by a query optimizer of the database management system and provides query plan fixes to the query optimizer.

14. The system of claim 13 wherein the utility means further associates a query to a prescribed plan and stores the query with the plan fix in a system catalog of the database management system for subsequent utilization by the query optimizer.

15. A computer program product having control logic stored therein, said control logic enabling a processor to, said control logic comprising:
first computer readable program code means for enabling a processor to identify query performance issues of chosen database operational logic in a database management system with an external utility provided for use on top of the database management system; and
second computer readable program code means for enabling a processor to resolve identified query performance issues selectively in the database management system without modifying the chosen database operational logic.

16. The computer program product of claim 15 wherein the database operational logic further comprises at least one of a query, a stored procedure, and an application.

17. The computer program product of claim 15 wherein the first computer readable program code means for enabling a processor to identify query performance issues further enables a processor to identify missing statistics for the chosen database operational logic and wherein the second computer readable program code means for enabling a processor to resolve identified query performance issues further enables a processor to update statistics in the database management system for the database operational logic with statistics found.

18. The computer program product of claim 15 wherein the first computer readable program code means for enabling a processor to identify query performance issues further enables a processor to identify suboptimal query optimization settings and wherein the second computer readable program code means for enabling a processor to resolve identified query performance issues further enables a processor to collect performance metrics and statistical information during operation by a query optimizer of the database management system and provide query plan fixes to the query optimizer.

19. The computer program product of claim 18 wherein the second computer readable program code means for enabling a processor to provide query plan fix further enables a processor to associate a query to a prescribed plan and store the query with the plan fix in a system catalog of the database management system for subsequent utilization by the query optimizer.

20. The computer program product of claim 15 wherein the first and second computer readable program code means further comprise JAVA/XML program code means.
